(19) United States
(12) Patent Application Publication
(10) Pub. No.: US 2009/0172593 A1
(43) Pub. Date: Jul. 2, 2009

(54) METHOD AND ELECTRONIC DEVICE FOR ALLOWING A USER TO SELECT A MENU OPTION

(75) Inventors: Lucas Jacobus Franciscus Geurts, Eindhoven (NL); Anton Oguzhan Alford Andrews, Seattle, WA (US); Judith Anges Josephina Peeten, Eindhoven (NL); Robert Kortenoeven, Milano (IT)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/299,811

(22) PCT Filed: May 1, 2007
(86) PCT No.: PCT/IB07/51608

§ 371 Date: Nov. 6, 2008

(30) Foreign Application Priority Data
May 8, 2006 (EP) 06113639.6

(51) Int. Cl. G06F 3/048

(52) U.S. Cl. 715/810; 715/863

(57) ABSTRACT

A method of allowing a user to select a menu option, which method comprises the steps of allowing the user to select a position (21) on a screen, displaying a plurality of menu option identifiers (23, 25) near the selected position (21) on the screen, defining a plurality of selection areas (27, 29), and allowing the user to select a specific one of the selection areas (27, 29) so as to select the menu option. Each selection area (27, 29) is located around a specific one of the menu option identifiers (23, 25) and has a size proportional to a distance between the specific one of the menu option identifiers (23, 25) and the selected position (21) on the screen. The method can be performed by an electronic device, possibly enabled by a computer program product.

The invention relates to a device for allowing a user to select a menu option.

The invention also relates to a method of allowing a user to select a menu option.

The invention further relates to a computer program product comprising software for enabling a programmable device to perform a method of allowing a user to select a menu option.

An example of such a method is known from Microsoft Windows XP. The known method allows a user to select a position on a screen, e.g. by allowing him to move a cursor to the position on the screen and clicking a button or by touching a position on the screen while holding a button, and displays a contextual drop-down pop-up menu near the selected position on the screen. It is a disadvantage of the known method that selection of a menu option from the drop-down menu requires a relatively precise movement of an input device, e.g. of a mouse or a pen. Users may find such precise movements difficult to realize.

It is a first object of the invention to provide an electronic device of the type described in the opening paragraph, which allows a user to select a menu option with less precise movement of an input device.

It is a second object of the invention to provide a method of the type described in the opening paragraph, which allows a user to select a menu option with less precise movement of an input device.

According to the invention, the first object is realized in that the electronic circuitry is configured to allow a user to select a position on a screen, display a plurality of menu option identifiers near the selected position on the screen, define a plurality of selection areas, each selection area being located around a specific one of the menu option identifiers and having a size proportional to a distance between the specific one of the menu option identifiers and the selected position on the screen, and allow the user to select a specific one of the selection areas so as to select a menu option corresponding to the specific selection area. The inventors have recognized that it becomes more difficult to select a menu option when a larger movement is required to select the menu option. By making the size of a selection area proportional to the required movement, it becomes less likely that the user needs to perform a sequence of several short movements instead of one long movement, and it also becomes less likely that the user accidentally navigates outside the selection areas and the menu accidentally disappears. The invention may be particularly beneficial to people that have problems with precise interaction, such as elderly people and young children. Although not required, the selection areas can be indicated on the screen in order to facilitate user selection.

The direction in which the menu option identifiers are displayed relative to the selected position on the screen preferably depends on whether the position is near an edge of the screen. When the position is near an edge of the screen, the direction should preferably be towards the center of the screen.

In an embodiment of the electronic device of the invention, the plurality of selection areas forms nested contours around the selected position. Nested contours allow the user to select a menu option by moving an input device in any of a plurality of directions, e.g. the direction that the user can most easily navigate in.

The contours may be circles. This form ensures that the selection areas have a sufficient thickness in many of the directions the user can navigate in. Furthermore, with normal pop-up menus, the positioning around the edges of the screen may create an undesired effect. If a pull-down menu is opened at the bottom of the screen, the menu will open up in the other direction (to the top). Nested circular menus do not have this ‘flipping’ behavior. They are more organic by nature, i.e. at the edges the menu can extend to the space on the screen that is available. This behavior is something the user expects and it feels more intuitive when compared to normal pop-up behavior.

The electronic circuitry may be configured to allow the user to select the specific one of the selection areas by dragging a finger, a pen or a pointer from the selected position across the nested circles. Although it is possible to allow the user to select the specific one of the selection areas by clicking another button, dragging is considered more intuitive. A highlight may be displayed on the screen while the user is dragging his finger, the pen or the pointer. Upon release, the selection area and thus the corresponding option will be selected.

The screen may be a touch screen. Precise movement is especially difficult when a touch screen is used.

The electronic circuitry may be configured to determine where to display each menu option identifier in dependence on an angle of a finger or a pen. When the angle is approximately 45 degrees (e.g. for right-handed users), it is often easier to move the pen or finger to the left. When the angle is approximately 135 degrees (e.g. for left-handed users), it is often easier to move the pen or finger to the right. The angle can be inferred by determining whether the input device is a left-hand or right-hand input device or is configured as such.

The electronic circuitry may be configured to determine where to display each menu option identifier in dependence on a movement of a finger or a pen before the user has selected the position on the screen. When the user moves his finger or pen in a certain direction before selecting a position on the screen, it is often easier to finish this movement than to make a second movement opposite the first movement. The movement can be detected with sensors, e.g. light or CCD sensors. The same sensors can be used to detect the angle of a pen or finger.

According to the invention, the second object is realized in that the method comprises the steps of allowing the user to select a position on a screen, displaying a plurality of menu option identifiers near the selected position on the screen, defining a plurality of selection areas, each selection area being located around a specific one of the menu option identifiers and having a size proportional to a distance between the specific one of the menu option identifiers and the selected position on the screen, and allowing the user to select a specific one of the selection areas so as to select the menu option, the selected menu option corresponding to the selected selection area.

These and other aspects of the invention are apparent from and will be further elucidated, by way of example, with reference to the drawings, in which:

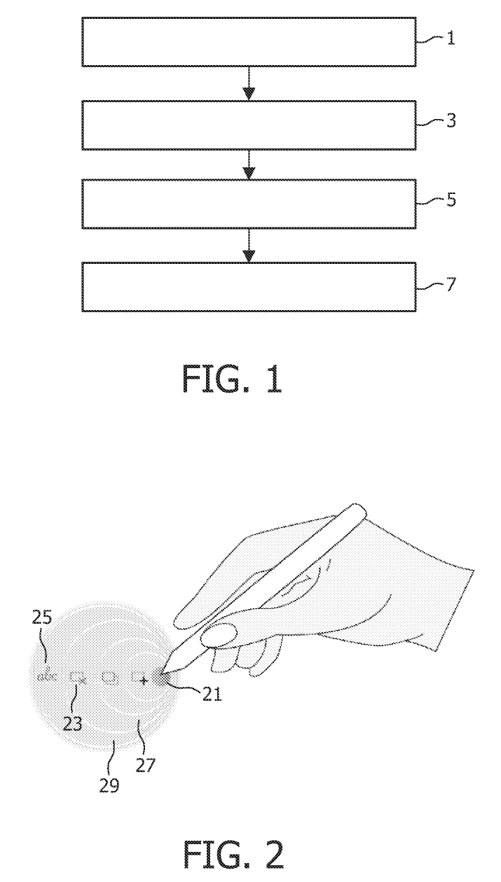

FIG. 1 is a flow diagram of the method of the invention;

FIG. 2 shows menu option identifiers and selection areas displayed by an embodiment of the electronic device of the invention; and

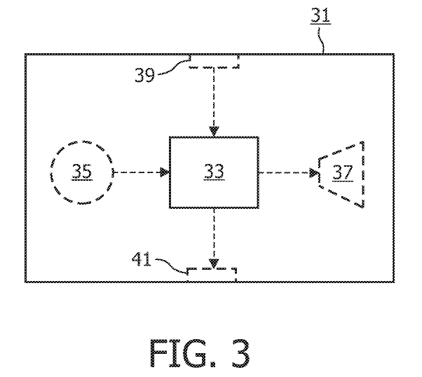

FIG. 3 is a block diagram of the electronic device of the invention.

Corresponding elements in the drawings are denoted by the same reference numerals.

The method of the invention comprises a step 1, a step 3, a step 5 and a step 7, see FIG. 1. Step 1 comprises allowing the user to select a position on a screen. Step 3 comprises displaying a plurality of menu option identifiers near the selected position on the screen. Step 5 comprises defining a plurality of selection areas, each selection area being located around a specific one of the menu option identifiers and having a size proportional to a distance between the specific one of the menu option identifiers and the selected position on the screen. Step 7 comprises allowing the user to select a specific one of the selection areas so as to select the menu option, the selected menu option corresponding to the selected selection area.

FIG. 2 shows an example of a nested circular menu displayed by an embodiment of the electronic device of the invention. After a user selects position 21 on a screen with a pen, four nested circles are displayed. The visible part of each of the four circles forms a selection area. Each circle contains a menu option identifier. Menu option identifier 25 corresponds to selection area 29 and menu option identifier 23 corresponds to selection area 27. A user is allowed to select one of the selection areas 27, 29 or one of the two other selection areas. When the pen hits the screen, a dot may be displayed from which the ring menu will open up. An animation may be used to enhance the effect. To enhance the effect even further, a sound like thin metal rings touching each other may be played. Sub-menus can be created by extending the menu with additional rings, but this may only be useful with the last ring in the menu. The previous rings can be collapsed into a dot to indicate that the user is navigating to a second menu level.

FIG. 3 shows the electronic device 31 of the invention. The electronic device 31 comprises electronic circuitry 33 configured to allow a user to select a position on a screen, display a plurality of menu option identifiers near the selected position on the screen, define a plurality of selection areas, each selection area being located around a specific one of the menu option identifiers and having a size proportional to a distance between the specific one of the menu option identifiers and the selected position on the screen, and allow the user to select a specific one of the selection areas so as to select a menu option corresponding to the specific selection area. The electronic device 31 may further comprise a storage means 35, a reproduction means 37, an input 39 and/or an output 41. The electronic device 31 may be a professional device or a consumer device, for example, a stationary or a portable device. The electronic circuitry 33 may be a general-purpose or an application-specific processor and may be capable of executing a computer program.

The storage means 35 may comprise, for example, a hard disk, a solid-state memory, an optical disc reader or a holographic storage means. The reproduction means 37 may comprise, for example, a display and/or a loudspeaker. The reproduction means 37 may be used to display the menu option identifiers. Alternatively, the output 41 may be used to display the menu option identifiers on an external display (not shown). The electronic device 31 may comprise an input means (not shown), e.g. a touch screen or a touch pad. Alternatively, the input 39 may be used to receive user input from an external input device (not shown). The external input device may be, for example, a mouse, a trackball or a digital pen. The definition of the selection areas may be transmitted to the external input device. In this case, the external input device only needs to transmit an indication of the selected selection area to the electronic device 33 instead of raw input data such as absolute or relative position data. The input 39 and output 41 may comprise, for example, a network connector, e.g. a USB connecter or an Ethernet connector, an analog audio and/or video connector, such as a cinch connector or a SCART connector, or a digital audio and/or video connector, such as a HDMI or SPDIF connector. The input 39 and output 41 may comprise a wireless receiver and/or transmitter.

While the invention has been described in connection with preferred embodiments, it will be understood that modifications thereof within the principles outlined above will be evident to those skilled in the art, and thus the invention is not limited to the preferred embodiments but is intended to encompass such modifications. The invention resides in each and every novel characteristic feature and each and every combination of characteristic features. Reference numerals in the claims do not limit their protective scope. Use of the verb “to comprise” and its conjugations does not exclude the presence of elements other than those stated in the claims. Use of the article “a” or “an” preceding an element does not exclude the presence of a plurality of such elements.

The invention can be implemented by means of hardware comprising several distinct elements, and by means of a suitably programmed computer. ‘Computer program product’ is to be understood to mean any software product stored on a computer-readable medium, such as a floppy disk, downloadable via a network, such as the Internet, or marketable in any other manner.

1. An electronic device (31) comprising electronic circuitry (33) to:
allow a user to select a position (21) on a screen;
display a plurality of menu option identifiers (23, 25) near the selected position (21) on the screen;
define a plurality of selection areas (27, 29), each selection area being located around a specific one of the menu option identifiers (23, 25) and having a size proportional to a distance between the specific one of the menu option identifiers (23, 25) and the selected position (21) on the screen; and
allow the user to select a specific one of the selection areas (27, 29) so as to select a menu option corresponding to the specific selection area.

2. An electronic device as claimed in claim 1, wherein the plurality of selection areas forms nested contours around the selected position.

3. An electronic device as claimed in claim 1, wherein the contours are circles.

4. An electronic device as claimed in claim 1, wherein the electronic circuitry (33) is configured to allow the user to select the specific one of the selection areas by dragging a finger, a pen or a pointer from the selected position across the nested circles.

5. An electronic device as claimed in claim 1, wherein the screen is a touch screen.

6. An electronic device as claimed in claim 1, wherein the electronic circuitry (33) is configured to determine where to display each menu option identifier in dependence on an angle of a finger or a pen.

7. An electronic device as claimed in claim 1, wherein the electronic circuitry (33) is configured to determine where to display each menu option identifier in dependence on a movement of a finger or a pen before the user has selected the position on the screen.

8. A method of allowing a user to select a menu option, the method comprising:
allowing (1) the user to select a position on a screen;
displaying (3) a plurality of menu option identifiers near the selected position on the screen;
defining (5) a plurality of selection areas, each selection area being located around a specific one of the menu option identifiers and having a size proportional to a distance between the specific one of the menu option identifiers and the selected position on the screen; and
allowing (7) the user to select a specific one of the selection areas so as to select the menu option, the selected menu option corresponding to the selected selection area.

9. A method as claimed in claim 8, wherein the plurality of selection areas forms nested contours around the selected position.

10. A computer program, embodied on a computer readable medium, for enabling a programmable device to perform the method of claim 8.
